(19) United States
(12) Patent Application Publication
(10) Pub. No.: US 2006/0280903 A1
(43) Pub. Date: Dec. 14, 2006

(54) Floor mat for a motor vehicle

(76) Inventor: Herve Van Respaille, Bondues (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/521,163

(22) PCT Filed: Jul. 17, 2003
(86) PCT No.: PCT/FR03/02260

§ 371 Date: Aug. 31, 2005

(30) Foreign Application Priority Data
Jul. 18, 2002 (EP) 02370032.1

(51) Int. Cl. B32B 3/06

(52) U.S. Cl. 428/100; 428/99

(57) ABSTRACT

Vehicle covering equipment, in particular an accessory mat, characterized in that it includes peripheral binding provided on at least two side edges of the mat and on its bottom face with hook-and/or-loop elements.

The invention relates to the technical field of floor mats for vehicle floors, in particular for motor vehicles.

Conventionally, automobile manufacturers cover the floors of vehicles in pieces of cut-out and stuck-down carpeting matching the dimensions and the shapes in relief of such floors.

Such a covering raises problems for cleaning since, as a general rule, the pieces of carpeting cannot be removed.

Furthermore, the carpeting used by manufactures for mass-production cars is generally short-pile carpeting of mediocre quality, of a color that does not always match the color of the seat covers, of the upholstery, or even of the bodywork itself.

To mitigate those difficulties and to give vehicle owners the option of arranging the insides of their vehicles as they see fit, certain accessory manufacturers make removable mat elements available to drivers for the purpose of being placed over the original mat elements.

Thus, it is becoming more and more widespread to cover the inside floor of a car, at the feet of the driver and of the passengers, by means of a carpet type mat, made of stitched polypropylene or polyamides or rubber and polyvinyl chloride (PVC). Such mats have taken the place of conventional rubber mats because they are more comfortable and because they improve the appearance of the inside of the car.

Examples of mats for fitting-out vehicles are to be found in the following documents:

the French patent applications published under the following numbers: 2 531 991, 2 535 277, 2 617 102, 2 641 747, 2 647 729, 2 672 019, 2 688 674, 2 688 742, 2 678 225, 2 690 115, 2 694 248, 2 708 533, 2 715 615, 2 754 222, 2 754 499, and 2 772 321;

the German patents and utility models published under the following numbers: 19814868, 4212502, 4142102, and 4141023;

the British patent applications published under the following numbers: 2 118 035, 2 171 901, and 2 171 902;

the European patent applications published under the following numbers: 0 028 715, 0 057 391, 0 177 664, 0 112 795, 0 203 677, 0 247 677, 0 258 162, 0 259 795, 0 309 777, 0 311 736, 0 343 271, 0 379 630, 0 512 904, 0 518 014, 0 560 557, 0 594 925, 0 718 148, 0 776 761, 0 829 391, and 0 834 423;

the United States patents granted under the following U.S. Pat. Nos. 1,883,737, 2,505,554, 3,337,258, 4,068,339, 4,349,594, 4,382,986, 4,406,492, 4,481,240, 4,673,603, 4,721,641, 5,236,241, and 5,725,926; and

the international patent applications published under the following numbers: 90/09906, 91/02665, 91/16218, 93/13254, 97/06029, and 98/19880.

The accessory carpets for placing inside motor vehicle bodies and known in the prior art can be organized in the following four categories:

doormat, i.e. a textile structure coated in a synthetic resin on its back face, with the textile structure constituting the front face of the mat. This type of mat has been in use for a long time (see document BE 344 323, for example);

needled carpeting or velvet, for example pieces of polypropylene carpeting edged in textile fiber binding;

a structure of molded synthetic resin (elastomer, rubber, . . . ), with this type of mat also being a very longstanding design (cf. document FR 541 419, for example); and

a structure of molded synthetic resin on which carpeting is fitted, e.g. by adhesive.

Mats covering the inside of bodywork need to present numerous qualities:

they must be flexible so as to fit closely over the uneven shapes of the floor, where said uneven shapes are associated in particular with wheel arches, with the central console between the front seats, with the transmission tunnel, and with footrest zones;

they must be capable of being used on vehicles from different manufacturers and of different models, in spite of the differences in three-dimensional shape between the floors of such vehicles; at present, this possibility of being usable in several different types of vehicle can be obtained only at the cost of reducing the area of such mats;

they must also present a high degree of resistance to wear by rubbing and by puncturing, in particular in the zones where the driver's heel bears against them; such puncturing is particularly problematic when the driver is a woman wearing high heels;

they must be pleasing in appearance and as personalized as possible;

they must present surface roughness so that a driver's foot cannot slide from its bearing point while engaged on a pedal, but such roughness (ribs, portions in relief, . . . ) must not lead to particles and grit being deposited to behave as an abrasive material leading to wear on a portion of a driver's shoe;

they must be comfortable, rot-proof, and easy to clean;

they must be suitable for being attractively presented on shelving in stores, so as to make it easy for consumers to choose mats that correspond both to their vehicle models and to their tastes;

they must employ materials that are compatible with regulations and with manufacturers' specifications (e.g. UPEC U3P3);

they must not be expensive; and

they must not allow hard fragments to pass between themselves and the floor covering (generally carpeting stuck thereto) where such hard fragments can become embedded in the backing of the mat and can spoil user comfort.

In addition to the qualities mentioned above, mats used inside bodywork must:

be capable of being easily removed without being too heavy so as to make them easy to shake-out in order to expel the grit and particles of earth or sand that have been brought into the vehicle on users' shoes;

be capable of being held in position without sliding on the floor or becoming wrinkled, in particular when the driver performs an emergency (braking) operation.

Keeping a mat in position is of very great importance.

If this is not ensured, the following problems are to be feared:

the driver can be impeded when actuating the brake or accelerator pedals, to such an extent as to prevent one or more of the control pedals of the vehicle from being operated; and

hard fragments can find their way between the mat and the floor covering, thereby prematurely wearing the lining during repeated sliding of the mat.

In order to keep an accessory mat in place, several techniques have been envisaged in the prior art.

A first technique consists in providing mat-fastening systems inside the vehicle cabin. These can be constituted, for example, by one or more pivoting fasteners secured to the floor of the vehicle and each designed to be passed through an eyelet provided in the mat.

When such fastener systems are preinstalled by the vehicle manufacturer, the consumer cannot use any commercially-available mat, since mat fastener systems are specific to each manufacturer, or even to such and such a model of vehicle. Nor can a consumer keep and reuse mats when changing vehicles.

When such fastener systems are sold together with an accessory mat, then the vehicle proprietor needs to drill holes in the vehicle floor in order to mount the fastener system. As a general rule, vehicle proprietors are very reluctant to carry out that type of operation.

A second technique consists in providing spikes or barbs on the back face of the accessory mat, i.e. on its face that comes into contact with the vehicle floor, such spikes or barbs increasing adhesion between the mat and the carpeting on the floor.

A third technique consists in fastening the accessory carpet by means of hook-and/or-loop strip or of double-sided adhesive strip applied to the back face of the mat.

The general principle of hook-and/or-loop strips has been known, per se, since the work of George de Mestral in 1948, which work led to the product known under the trade name Velcro.

For those various prior art techniques, reference can be made, for example, to the following documents:

the United States patents published under the U.S. Pat. Nos. 4,262,048, 4,588,628, 4,671,981, 4,765,670, 4,804,567, 4,810,024, 4,968,548, 4,998,319, 5,003,664, 5,358,768, and 6,238,765;

international patent applications published under the numbers 95/34443, 97/06029, 97/16218, and 01/34431;

European patent applications published under the numbers 0 177 664, 0 112 795, 0 211 966, 0 311 736, 0 560 557, 0 594 925, 0 612 492, and 0 899 154; and

French patent applications published under the numbers 2 009 185, 2 296 117, 2 489 134, 2 677 590, and 2 772 321.

None of the prior techniques for fastening accessory mats or over-mats has been found to be entirely satisfactory.

In particular, the use of hook-and/or-loop strips requires an additional manufacturing operation. Furthermore, the hooks of the male strip are difficult to position accurately relative to the loops of the female strip, and the user needs to begin again several times over in order to achieve proper positioning of mats provided with Velcro® type strips.

Using double-sided adhesive strip leads rapidly to the adhesive becoming clogged and to a loss of mat retention.

Mats that are sold for retrofitting and that are provided with a back face that is granular or that carries a foam tend to deform in use, and above all to slide under the pedals in the event of a sudden movement, thereby running the risk of an accident, e.g. during emergency braking.

The present invention seeks to provide an accessory mat or over-mat, or more generally vehicle covering equipment that does not present the drawbacks known in the past, said mat being removable, in particular for cleaning purposes, and not sliding while it is in use.

To this end, in a first aspect, the invention provides vehicle covering equipment, in particular an accessory mat, including peripheral binding provided on at least two side edges of the mat and on its bottom face with hook-and/or-loop elements.

In an embodiment, the binding has no hook-and/or-loop elements on its side face or on its top face.

In another embodiment, the binding is provided with hook-and/or-loop elements both on its bottom face and on its top face, the mat thus being reversible. This disposition is advantageous in particular when one face of the mat is worn or of a color different from the other face, or indeed when it is desired to fit an additional element on the top face of the mat, for example a transparent film or a reinforcing strip.

In an advantageous embodiment, the hook-and/or-loop elements are in the form of hooks.

The original mat is usually constituted by needled carpeting of the flat or loop type, or of tuft covering the bottom of the vehicle body, so the hook-and/or-loop elements grip directly to the bristles of the floor mat.

The term “bristles” is used herein to designate any fiber, plush, downy, knitted, or cellular material that can be caught by the binding with its hooks or its rods provided with end swellings.

The binding may be secured by heat-sealing or by adhesive, or indeed by stitching, in conventional manner.

In one embodiment, the binding is provided with hook-and/or-loop elements over substantially its entire length.

In certain embodiments, the binding is provided with female elements of the loop or equivalent type, at least over a portion of its area. In some variants, the male and female elements that are known in themselves for hook-and/or-loop strips, are disposed on the binding in random or intermittent manner. For example, the binding may have alternating male and female segments.

By using a mixture or an alternation of male and female elements it is possible:

to predetermine the resistance of the mat with the binding to being torn away from or to sliding over a given mat-receiving surface;

to place the mat with the binding on a support such as needled carpeting or indeed a Velcro type strip carrying male and/or female elements.

The mat of the invention retains the flexibility specific to the materials used for making the central portion thereof whose edges carry the binding.

The mat is easy to remove, e.g. for cleaning purposes, while nevertheless presenting great resistance to sliding.

1. Vehicle covering equipment, in particular an accessory mat, the equipment being characterized in that it includes peripheral binding provided on at least two side edges of the mat and on its bottom face with hook-and/or-loop elements.

2. Covering equipment according to claim 1, characterized in that the binding has no hook-and/or-loop elements on its side face or on its top face.

3. Covering equipment according to claim 1 or claim 2, characterized in that the hook-and/or-loop elements are in the form of hooks.

4. Covering equipment according to any one of claims 1 to 3, characterized in that the binding is secured by stitching, heat-sealing, or adhesive.

5. Covering equipment according to any one of claims 1 to 4, characterized in that the binding is provided with hook-and/or-loop elements over substantially its entire length.

6. Covering equipment according to any one of claims 1 to 5, characterized in that the binding includes male and female hook-and-loop elements disposed in random or intermittent manner.
